(19) United States
(12) Patent Application Publication
(10) Pub. No.: US 2025/0099900 A1
(43) Pub. Date: Mar. 27, 2025

(54) CARBON CAPTURE SYSTEM

(71) Applicant: DELTA ELECTRONICS, INC., Taoyuan City (TW)

(72) Inventors: Chin-Chun LAI, Taoyuan City (TW); Po-Cheng KUNG, Taoyuan City (TW); Li-Chia CHEN, Taoyuan City (TW); Kun-Fu CHUANG, Taoyuan City (TW); Chia-Feng WU, Taoyuan City (TW)

(21) Appl. No.: 18/895,951

(22) Filed: Sep. 25, 2024

Related U.S. Application Data
(60) Provisional application No. 63/540,640, filed on Sep. 26, 2023.

(51) Int. Cl. B01D 53/04

(52) U.S. Cl. CPC B01D 53/0407; B01D 2257/504; B01D 2259/40088

(57) ABSTRACT

This disclosure is directed to a carbon capture system having an adsorption module, a fan module, a desorption chamber and a desorption line. The adsorption module has a plurality of adsorption units arranged in a coplanar array. Each of the adsorption units has a frame and a plurality of adsorption structures. The frame has an inlet end and an exhaust end. The adsorption structures are arranged in the frame, and the adsorption module is defined with a flow direction from the inlet ends toward the exhaust ends. The fan module is defined with an air outlet direction, and the air outlet direction is arranged along the flow direction. The desorption chamber is used for accommodating the adsorption module. One end of the desorption pipeline is connected to the desorption chamber, and the desorption pipeline is connected with a gas storage tank and a negative pressure pump arranged in series.

### CROSS-REFERENCE TO RELATED APPLICATION

This patent application claims the benefit of U.S. Provisional Patent Application No. 63/540,640, filed Sep. 26, 2023, which is incorporated by reference herein.

### BACKGROUND OF THE INVENTION

### Technical Field

This disclosure is directed to a system of carbon capture, utilization and storage (CCUS), in particular to a carbon capture system for capturing carbon dioxide from ambient air.

### Description of Related Art

Adsorption gas separation is a commonly used industrial method. In recent years, in order to achieve climate protection goals, methods for removing CO₂ (carbon dioxide) from industrial waste gases or the atmosphere, especially the latter method called direct air capture (DAC), have applied favorable energy sources and related infrastructure, there are many previous cases to reduce carbon dioxide emissions into the atmosphere, thereby reducing the greenhouse effect.

Carbon capture, utilization and storage (CCUS) system involves the capture of carbon dioxide, generally from large point sources such as power generation or industrial facilities that use either fossil fuels or biomass as fuel. CCUS can tackle emissions in hard-to-abate sectors, particularly heavy industries like cement, steel, or chemicals. CCUS is an enabler of least-cost low-carbon hydrogen production, which can support the decarbonization of other parts of the energy system, such as industry, trucks, and ships. CCUS can remove carbon dioxide from the air to balance emissions that are unavoidable or technically difficult to abate.

A CCUS system of related art is generally large, and it is therefore inconvenient to transfer to a desorption equipment after an adsorption process.

### SUMMARY OF THE INVENTION

This disclosure is directed to a carbon capture system for capturing carbon dioxide from ambient air.

This disclosure is directed to a carbon capture system having an adsorption module, a fan module, a desorption chamber and a desorption line. The adsorption module has a plurality of adsorption units arranged in a coplanar array, each of the adsorption units has a frame and a plurality of adsorption structures, the frame of each adsorption unit has an inlet end and an exhaust end, the adsorption structures are disposed in the frame and fixed between the inlet end and the exhaust end, the inlet end is disposed at one side of the adsorption module, and the exhaust end is disposed at another sided of the adsorption module, and a flow direction is defined corresponding to the adsorption module, the flow direction is defined from the inlet ends toward the exhaust ends. The fan module is arranged corresponding to the adsorption module, an air outlet direction is defined corresponding to the fan module, and the air outlet direction is disposed along the flow direction. The desorption chamber is used for accommodating the adsorption module, and a heater is arranged in the desorption chamber. The desorption line has an end connected to the desorption chamber, the desorption line strings a gas storage tank and a negative pressure pump, and the negative pressure pump is disposed between the desorption chamber and the gas storage tank along the desorption line.

In one of the exemplary embodiments, the carbon capture system further has a rail connected with the desorption chamber, and the adsorption module disposed on the rail and movable along the rail. The fan module is disposed outside of the desorption chamber, and the rail is connected between the desorption chamber and the fan module. The adsorption module is located outside of the desorption chamber when the adsorption module is adsorbing.

In one of the exemplary embodiments, the desorption chamber has an inlet gate, and the adsorption module is arranged in the desorption chamber. The fan module is disposed outside of the desorption chamber desorption chamber. The inlet gate is open when adsorption module is adsorbing.

In one of the exemplary embodiments, the carbon capture system further has a weight sensor, and the weight sensor attached on the adsorption module for measuring a weight of the adsorption module.

In one of the exemplary embodiments, the desorption line further strings a temporary gas storage tank and a compression pump. The compression pump is disposed between the temporary gas storage tank and the gas storage tank, the temporary gas storage tank is disposed between the negative pressure pump and the compression pump.

According to this disclosure, the carbon capture system has an adsorption module integrated with the desorption chamber and the desorption line, thereby facilitating conversion for adsorption and desorption.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing a carbon capture system in an adsorption process according to the first embodiment of this disclosure;

FIG. 2 is a perspective view showing an adsorption module and a fan module of the carbon capture system according to the first embodiment of this disclosure;

FIG. 3 is a perspective view showing an embodiment of the adsorption module of the carbon capture system according to first embodiment of this disclosure;

FIG. 4 is a perspective view showing another embodiment of the adsorption module of the carbon capture system according to first embodiment of this disclosure;

FIG. 5 is a perspective view showing the carbon capture system in a desorption process according to first embodiment of this disclosure;

FIG. 6 is a perspective view showing the carbon capture system in an adsorption process according to the second embodiment of this disclosure;

FIG. 7 is a perspective view showing the carbon capture system in a desorption process according to the second embodiment of this disclosure; and

FIG. 8 is a perspective view showing the carbon capture system according to the third embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Detailed descriptions and technical contents of this disclosure is described in the flowing paragraph with reference to the drawings. However, the drawings are attached only for illustration and are not intended to limit this disclosure.

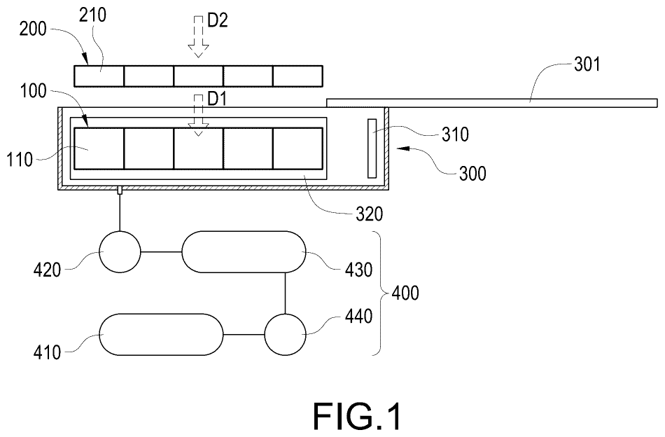

In order to reduce the greenhouse effect, this disclosure provides a carbon capture system for capturing carbon dioxide from ambient air. The ambient air recited in this disclosure may be industrial waste gas or atmosphere containing carbon dioxide. Referring to a carbon capture system in an adsorption process according to the first embodiment of this disclosure as shown in FIG. 1. In this embodiment, the carbon capture system has an adsorption module 100, a fan module 200 a desorption chamber 300 for accommodating the adsorption module 100 and a desorption line 400. The adsorption module 100 is provided with a plurality of adsorption units 110 and defined with a flow direction D1, a weight sensor 320 for measuring a weight change of the adsorption module 100 is correspondingly arranged on the adsorption module 100. The fan module 200 is arranged corresponding to the adsorption module 100, the fan module 200 is provided with a plurality of fans 210 and defined with an air outlet direction D2. The desorption chamber 300 has an inlet gate 301, the adsorption module 100 and the weight sensor 320 are arranged in the desorption chamber 300 according to this embodiment, and a heater 310 is provided in the desorption chamber 300. The desorption line 400 has one end connected to the desorption chamber 300, the desorption line 400 strings a gas storage tank 410 and a negative pressure pump 420, and the desorption line further strings a temporary gas storage tank 430 and a compression pump 440 in this embodiment, so that the gas storage tank 410, negative pressure pump 420, the temporary gas storage tank 430 and a compression pump 440 are fluid communicated in a pre-determined sequence via the desorption line 400.

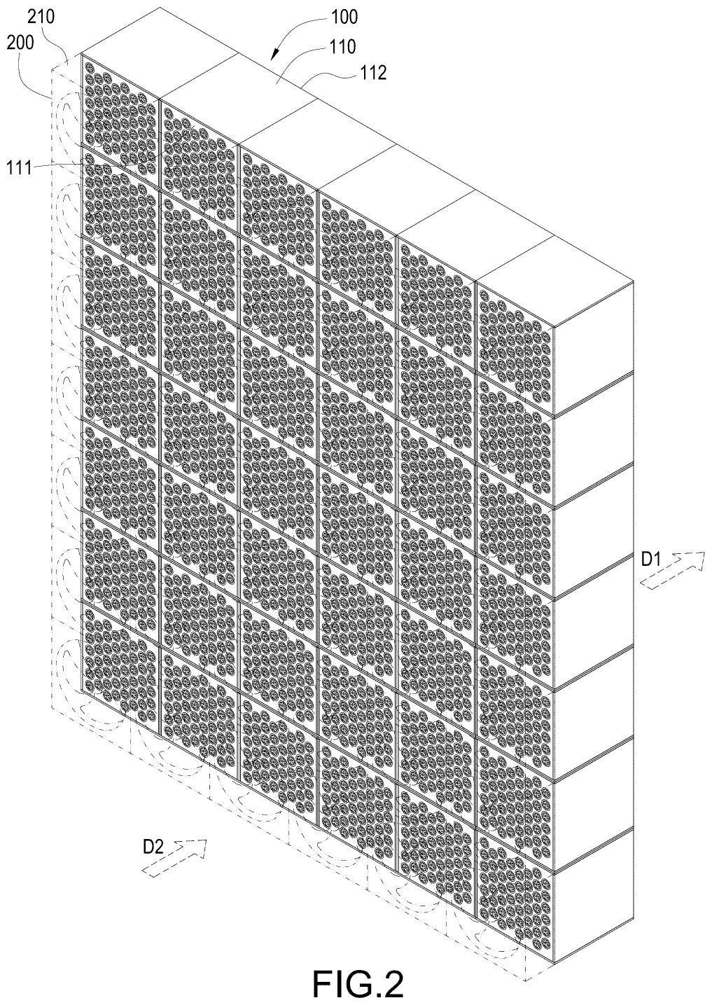

FIG. 2 is a perspective view showing a carbon capture system, an adsorption module thereof and a fan module thereof. Referring to FIGS. 1 and 2, the adsorption module 100 is suitable for an adsorption process in a room temperature environment and a desorption process in a high temperature environment. According to this embodiment, the adsorption module 100 has a plurality of adsorption units 110 arranged in a coplanar array, the adsorption module 100 has an inlet side 101 and an exhaust side 102, and the adsorption module 100 may selectively further have a rack (not shown in figures) as a structure for supporting the stacked adsorption units 110. Each of the adsorption units 110 has an inlet end 111 and an exhaust end 112. According to this embodiment, the inlet ends 111 of the adsorption units 110 are disposed at the inlet side 101 of the adsorption module 100, the exhaust ends 112 are disposed at the exhaust side 102 of the adsorption module, and the adsorption module 100 is defined with a flow direction D1 which is a direction from the inlet end 111 to the exhaust end 112. The fan module 200 has a plurality of fans 210 arranged in a coplanar array, the fan 210 are disposed along the same air outlet direction D2, and the fans 210 may be arranged corresponding to the adsorption units 110. The air outlet direction D2 of the fan module 200 is disposed along the flow direction D1 of the adsorption module 100 for increasing a flux through the adsorption module 100 to improve an adsorption efficiency of the adsorption module 100. According to this embodiment, the fan module 200 is disposed at an upstream of the flow direction D1 of the adsorption module 100 and arranged outside of the desorption chamber 300. However, the fan module 200 and the adsorption module 100 may be arranged together in the desorption chamber 300. Moreover, the fan module 200 may be disposed at a downstream of the flow direction D1 of the adsorption module 100.

The adsorption units 110 of this disclosure should not be limited to the embodiment mentioned above. Various embodiments are illustrated below as examples, but the scopes of this disclosure should not be limited to this.

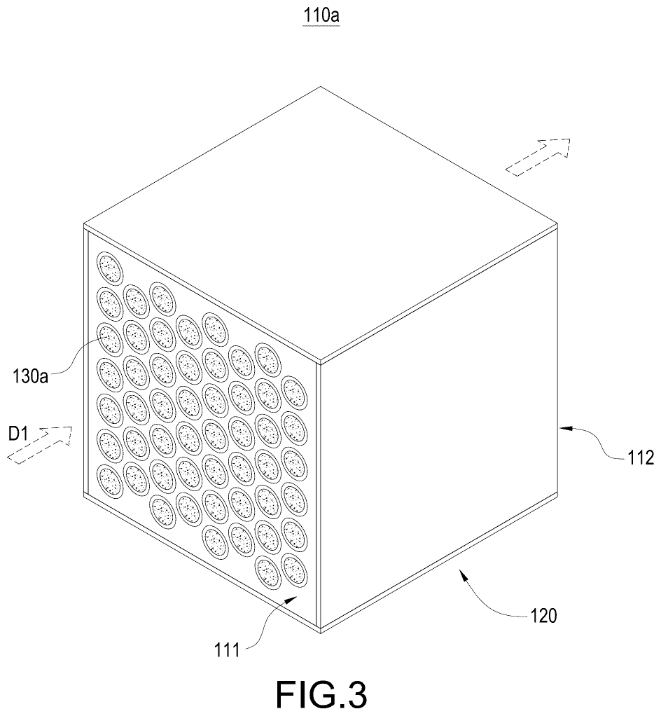

Referring to an adsorption units 110a as shown in a perspective view of FIG. 3, each of the adsorption units 110a has a frame 120 and a plurality of adsorption structures 130a. In each of the adsorption units 110a the frame 120 has an inlet end 111 and an exhaust end 112, the adsorption structures 130a is disposed in the frame 120 and the adsorption structures 130a are restricted by structural parts (e.g. tubes) to be fixed between the inlet end 111 and the exhaust end 112. Specifically, the inlet end 111 and the exhaust end 112 on the frame 120 of the adsorption unit 110a are open, and the rest portions of the frame 120 (other than the inlet side 101 and the exhaust side 102) are closed.

According to this disclosure, the molecular sieve is used as an adsorption material for adsorbing carbon dioxide or water. The adsorption material is a powdery adsorption material in original, and the powdery adsorption material is sintered into a granular adsorbent material applied in the adsorption unit adsorption unit 11 of this disclosure. The molecular sieve is a solid chemical functionalized adsorbent material, which is suitable for adsorbing carbon dioxide with a concentration of approximately 400 ppm. The Molecular sieve adsorbs carbon dioxide and water at room temperature namely between 25° C. and 35° C. The adsorption efficiency decreases with a temperature increasing, and the molecular sieve stops adsorbing and begins to desorb at a temperature higher than 60° C. The molecular sieve has at least the components of K₂O (potassium oxide), CaO (calcium oxide), Al₂O₃ (aluminum oxide), SiO₂ (silicon dioxide) and Na₂O (sodium oxide). The melting point of the molecular sieve is approximately 2230° C. The particles of the molecular sieve have a density within 0.65-0.8 g/cm³.

According to the adsorption units 110a as shown in FIG. 3, the adsorption structures 130a are granules made of the adsorption material, and the adsorption material is molecular sieve. The adsorption granules 130a are arranged in the frame 120 and between the inlet end 111 and the exhaust end 112. The adsorption units 110a of this disclosure has the frame 120 for limiting the flow direction D1 of airflow. Accordingly, the air enters the adsorption unit 110a from the environment through the inlet end 111, then passes through the adsorption unit 110a and exits the adsorption unit through the exhaust end 112. The ambient air is contacted with the adsorption structures 130a when passing through the adsorption unit 110a, so that the carbon dioxide and water carried therein are adsorbed by the adsorption structures 130a. A part of the carbon dioxide and water contained in the air is removed in the adsorption unit 110a, and then the air is exhausted from the adsorption unit 110a through the exhaust end 112 and returned to the environment.

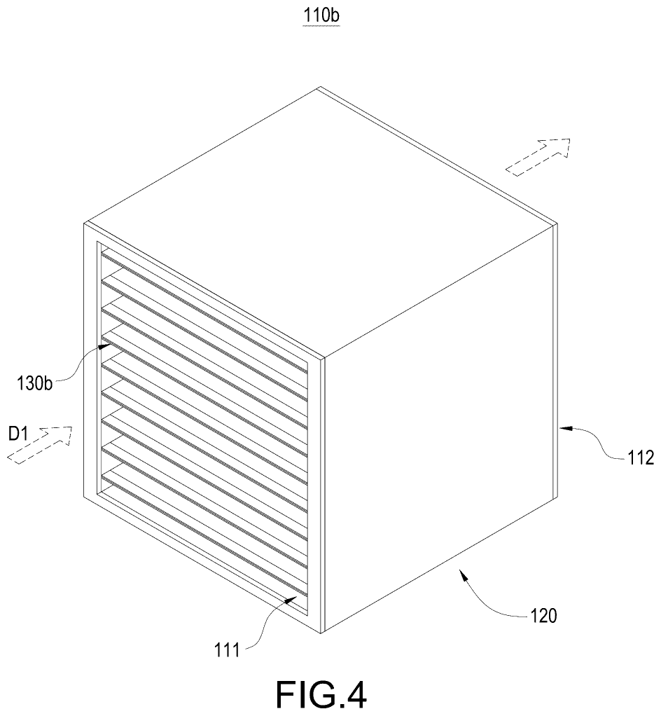

Referring to adsorption units 110b according to another embodiment of this disclosure as shown in FIG. 4, each of the adsorption units 110b has a frame 120 and a plurality of adsorption structures 130b. In each of the adsorption units 110b, the frame 120 has an inlet end 111 and an exhaust end 112, the adsorption structures 130b are separated into a plurality of bags arranged in the frame 120, thereby fixing the adsorption structures 130b between the inlet end 111 and the exhaust end 112.

Then referring to FIG. 1, the carbon capture system according to this disclosure is suitable for an adsorption process in a room temperature environment. In the adsorption process, the inlet gate of the desorption chamber 300 is open to allow air to enter the desorption chamber 300 and further passing through the adsorption module 100. The air passing through the adsorption module 100 is exhausted through the inlet gate 301 in an opened status or another additional opening of the desorption chamber 300. Since the desorption chamber 300 is connected to an end of the desorption line 400, the air passing through the adsorption module 100 may be exhausted through the desorption line 400. In the adsorption process, the adsorption units 110 gains weight by adsorbing carbon dioxide and/or water. A weight change of the adsorption module 100 is considered as the weight of carbon dioxide and water adsorbed in the adsorption module 100. The adsorption is completed when the weight sensor 320 measures that the weight of the adsorption units is increased upon a predetermined value, and the adsorption then stops adsorbing to start desorption.

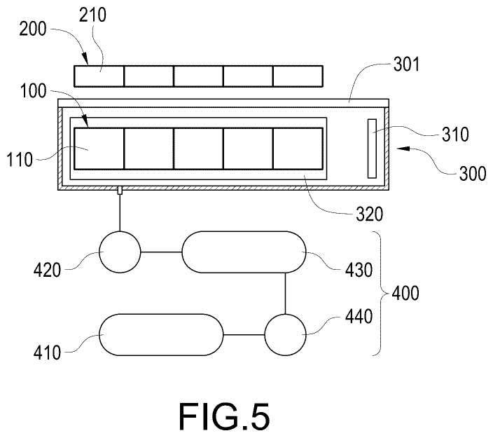

FIG. 5 is a perspective view showing the carbon capture system in a desorption process according to first embodiment of this disclosure. The carbon capture system is suitable for a desorption process in a high temperature environment. Referring to FIG. 5, the adsorption units 110 performs a desorption process in a desorption chamber 300 which can be sealed. In the desorption process, the inlet gate 301 of the desorption chamber 300 is closed to seal the desorption chamber 300, and the desorption chamber 300 is communicated to the desorption line 400. The interior of the desorption chamber is heated by the heater 310 to a desorption temperature of the molecular sieve so as to release carbon dioxide and water from the adsorption units 110, the desorption chamber is vacuumed by the negative pressure pump 420 to exhaust carbon dioxide and water which are released previously adsorption units 110, and carbon dioxide and water are then stored in a container for further processes. Specifically, the negative pressure pump 420 is disposed between the desorption chamber 300 and the gas storage tank 410 along the desorption line, a desorption gas containing carbon dioxide is pumped into the gas storage tank 410 by the negative pressure pump 420 for storage, and water is condensed and then collected or exhausted. Corresponding to requirements of pressing, the temporary gas storage tank 430 and the compression pump 440 may be selectively installed on the desorption line 400, and the compression pump 440 is disposed between the temporary gas storage tank 430 and the gas storage tank 410, the temporary gas storage tank 430 is arranged between the negative pressure pump 420 and the compression pump 440. The desorption gas is pumped into temporary gas storage tank 430 by the negative pressure pump 420, and the desorption gas in the temporary gas storage tank 430 is then compressed by the compression pump and pumped into the gas storage tank 410, so that the compressed desorption gas in the gas storage tank 410 has a purity of carbon dioxide up to 90% to 99%.

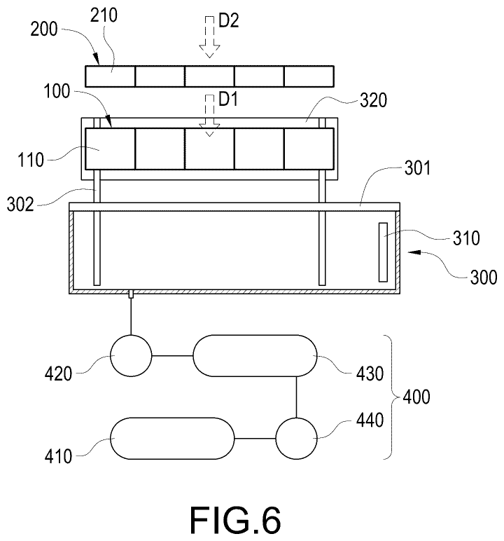

FIG. 6 is a perspective view showing the carbon capture system in an adsorption process according to the second embodiment of this disclosure. Referring to FIG. 6, in this embodiment, the carbon capture system has an adsorption module 100, a fan module 200, a desorption chamber 300 for accommodating the adsorption module 100 and a desorption line 400.

The adsorption module 100 is provided with a plurality of adsorption units 110 and defined with a flow direction D1, a weight sensor 320 for measuring a weight change of the adsorption module 100 is correspondingly arranged on the adsorption module 100.

The fan module 200 is arranged corresponding to the adsorption module 100, the fan module 200 is provided with a plurality of fans 210 and defined with an air outlet direction D2.

The desorption chamber 300 has an inlet gate 301. According to this embodiment, the adsorption module 100, the fan module 200 and the weight sensor 320 are arranged outside of the desorption chamber 300, namely in the external environment or in another room. A heater 310 is provided in the desorption chamber 300. The carbon capture system further has a rail 302 connected with the desorption chamber 300, the adsorption module 100 is disposed on the rail 302 and movable along the rail 302 to move into or leave from the desorption chamber 300. Specifically, the rail is connected between the desorption chamber 300 and the fan module 200.

The desorption line 400 has one end connected to the desorption chamber 300, the desorption line 400 strings a gas storage tank 410 and a negative pressure pump 420, and the desorption line further strings a temporary gas storage tank 430 and a compression pump 440 in this embodiment.

In the adsorption process, the fan module 200 drives air to pass through the adsorption module 100, the adsorption units 110 gains weight by adsorbing carbon dioxide and/or water. A weight change of the adsorption module 100 is considered as the weight of carbon dioxide and water adsorbed in the adsorption module 100. The adsorption is completed when the weight sensor 320 measures that the weight of the adsorption units is increased upon a predetermined value, and the adsorption then stops adsorbing to start desorption.

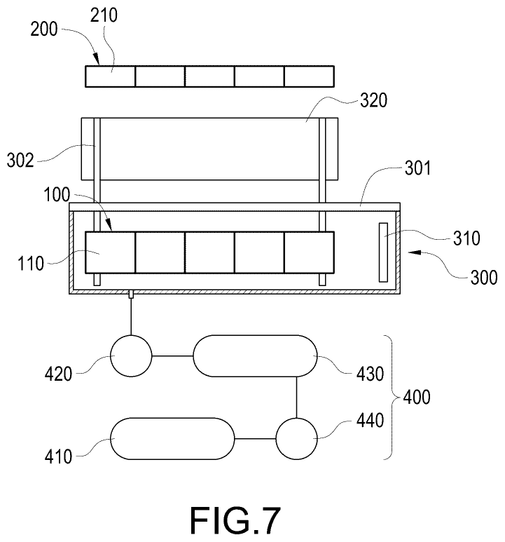

FIG. 7 is a perspective view showing the carbon capture system in a desorption process according to the second embodiment of this disclosure. The carbon capture system is suitable for a desorption process in a high temperature environment. Referring to FIG. 7, the adsorption units 110 performs a desorption process in a desorption chamber 300 which can be sealed. In the desorption process, the inlet gate 301 is opened to allow the adsorption module 100 to move into the desorption chamber 300 via the rail 302. In the desorption process, the inlet gate 301 of the desorption chamber 300 is closed to seal the desorption chamber 300, and the desorption chamber 300 is communicated to the desorption line 400. The interior of the desorption chamber is heated by the heater 310 to a desorption temperature of the molecular sieve so as to release carbon dioxide and water from the adsorption units 110, the desorption chamber is vacuumed by the negative pressure pump 420 to exhaust carbon dioxide and water which are released previously from the adsorption units 110, and carbon dioxide and water are then stored in a container for further processes. Specifically, the negative pressure pump 420 is disposed between the desorption chamber 300 and the gas storage tank 410 along the desorption line, a desorption gas containing carbon dioxide is pumped into the gas storage tank 410 by the negative pressure pump 420 for storage, and water is condensed and then collected or exhausted. Corresponding to requirements of pressing, the temporary gas storage tank 430 and the compression pump 440 may be selectively installed on the desorption line 400, and the compression pump 440 is disposed between the temporary gas storage tank 430 and the gas storage tank 410, the temporary gas storage tank 430 is arranged between the negative pressure pump 420 and the compression pump 440. The desorption gas is pumped into temporary gas storage tank 430 by the negative pressure pump 420, and the desorption gas in the temporary gas storage tank 430 is then compressed by the compression pump and pumped into the gas storage tank 410, so that the compressed desorption gas in the gas storage tank 410 has a purity of carbon dioxide up to 90% to 99%.

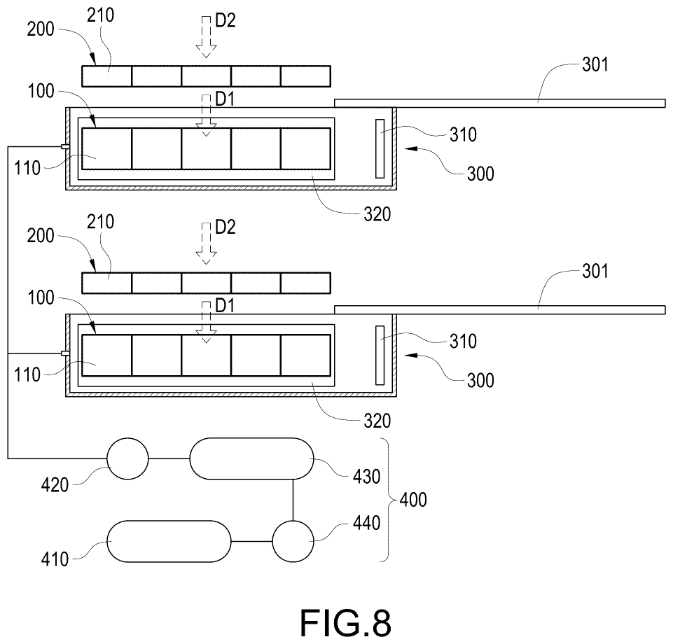

FIG. 8 is a perspective view showing the carbon capture system according to the third embodiment of this disclosure. According to FIG. 8, the adsorption material can adsorb carbon dioxide and water at the same time, considering this, a plurality of adsorption modules 100 are used cooperatively to improve adsorptions of water and carbon dioxide and result in a higher concentration of carbon dioxide adsorbed in the adsorption modules 100, and the carbon capture system may have multiple desorption chambers 300 correspondingly. The desorption line 400 is connected to each desorption chamber 300, the desorption line 400 is provided with a temporary gas storage tank 430 and a compression pump 440 as mentioned above and may be selectively provided with a temporary gas storage tank 430 and a compression pump 440 corresponding to requirements of pressing.

According to this disclosure, the carbon capture system has an adsorption module 100 integrated with the desorption chamber 300 and the desorption line 400, thereby facilitating conversion for adsorption and desorption.

While this disclosure has been described by means of specific embodiments, numerous modifications and variations could be made thereto by those skilled in the art without departing from the scope and spirit of this disclosure set forth in the claims.

What is claimed is:

1. A carbon capture system, comprising:
an adsorption module, comprising a plurality of adsorption units arranged in a coplanar array, each of the adsorption units comprising a frame and a plurality of adsorption structures, the frame of each adsorption unit comprising an inlet end and an exhaust end, the adsorption structures disposed in frame and fixed between the inlet end and the exhaust end, the inlet end disposed at one side of the adsorption module, and the exhaust end disposed at another side of the adsorption module, and a flow direction defined corresponding to the adsorption module, the flow direction defined from the inlet ends toward the exhaust ends;
a fan module, arranged corresponding to the adsorption module, an air outlet direction defined corresponding to the fan module, and the air outlet direction disposed along the flow direction;
a desorption chamber for accommodating the adsorption module, and a heater arranged in the desorption chamber; and
a desorption line, comprising an end connected to the desorption chamber, the desorption line stringing a gas storage tank and a negative pressure pump, and the negative pressure pump disposed between the desorption chamber and the gas storage tank along the desorption line.

2. The carbon capture system according to claim 1, further comprising a rail connected with the desorption chamber, and the adsorption module disposed on the rail and movable along the rail.

3. The carbon capture system according to claim 2, wherein the fan module is disposed outside of the desorption chamber, and the rail is connected between the desorption chamber and the fan module.

4. The carbon capture system according to claim 2, wherein the adsorption module is located outside of the desorption chamber when the adsorption module is adsorbing.

5. The carbon capture system according to claim 1, wherein the desorption chamber comprises an inlet gate, and the adsorption module is arranged in the desorption chamber.

6. The carbon capture system according to claim 5 wherein the fan module is disposed outside of the desorption chamber desorption chamber.

7. The carbon capture system according to claim 5, wherein the inlet gate is open when adsorption module is adsorbing.

8. The carbon capture system according to claim 1, further comprising a weight sensor, and the weight sensor attached on the adsorption module for measuring a weight of the adsorption module.

9. The carbon capture system according to claim 1, wherein the desorption line further strings a temporary gas storage tank and a compression pump.

10. The carbon capture system according to claim 9, wherein the compression pump is disposed between the temporary gas storage tank and the gas storage tank, the temporary gas storage tank is disposed between the negative pressure pump and the compression pump.
